(19) United States
(12) Patent Application Publication
(10) Pub. No.: US 2006/0170133 A1
(43) Pub. Date: Aug. 3, 2006

(54) Face and head casting system

(76) Inventor: Mark Kephart Taiz, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 11/050,486

(22) Filed: Feb. 2, 2005

(51) Int. Cl. B29C 33/40

(52) U.S. Cl. 264/222; 425/2

(57) ABSTRACT

A face and head casting system including a platform and a dome is used to quickly create a face cast while maintaining the comfort of the subject of the face cast. The platform supports the weight of the casting material while the dome acts as a mother mold, providing support for the resulting face cast. One or more tubes are adapted to seal the subject's nostrils, preventing casting material from entering the subject's nose, while allowing the subject to breath without deforming the nostrils. These breathing tubes may be custom made for each subject or selected from a variety of pre-made tubes of common sizes. The face casting system may be used in a reclining position, a sitting position, or while the subject is standing to more fully capture the subject's features while subjected to the force of gravity.

### BACKGROUND OF THE INVENTION

1. Field of the Invention

This invention is related in general to the field of casting systems. In particular, the invention consists of a system for creating a negative cast of a person's face and head.

2. Description of the Prior Art

The art of making a cast of a person's face has been well known for many centuries. Thousands of years ago, Egyptian priests made clay facsimiles of their kings when they died in an attempt to perpetuate their existence. These facsimiles were created by placing a malleable material over the subject's face. This malleable material would then set into a non-deformable impression of the subject. These copies were called death masks, as they were made after the kings had died. Subsequent masks, referred to as life masks, were made from living persons. However, this required that the subject of the mask be able to breath during the casting process. This was accomplished by having the subject breathe through straws. Alternatively, the cast at the tip of the nose was left unfinished and completed later.

The cast made from a person's face is known as a negative cast, as a subject's protrusions create recesses in the cast and vice versa. In order to create a positive cast, the negative cast must be used as a mold. Placing a malleable substance into the mold (or imprint) of the face and allowing it to set will create a positive cast or facsimile of a person's face once removed from the mold.

Today, face and full head castings have many uses. A face cast is essential for providing a model for developing facial prosthetics that may be worn by the subject for cinema and theatrical performance. Although never made available before, face casts may also be used as models for pre-surgery, surgery, and post surgery visualization of cosmetic, reconstructive, and dental procedures. Before and after face and full head casts may be used as records for medical data bases that could be particularly valuable to reconstruct the faces of high-risk professionals such as firemen and race-car drivers. Additionally, a face cast may serve as a model for the development of face recognition security systems or as a custom mask, portrait or bust.

A traditional method of creating a face mask involves having a subject recline or lay in a prone position. Common plastic drinking straws are placed in the subject's nose to allow him to breathe during the casting process. Plaster of Paris is applied to the subject's face and allowed to harden. One problem with this approach is that the plaster weighs heavily upon the subject's face and creates discomfort. Another problem is that the plaster takes an extensive amount of time to set, adding to the subject's discomfort, especially if the subject dislikes confined spaces. Yet another problem is that the plaster generates heat during the curing process, adding yet additional discomfort to the subject. Accordingly, it is desirable have a method of creating a face cast that does not involve significant periods of time, does not weigh heavily on the face of the subject, and does not produce excessive heat.

A more current method of creating a face mask involves using an alginate, a gelatin made from seaweed, instead of plaster of Paris. Because the alginate sets in a minimal amount of time, a subject could create a mask by holding his breath and placing his face into a bowl of liquid alginate. However, many people would be wary of plunging their face into a bowl of thick casting material without being able to breath. Additionally, a subject may accidentally draw a breath during the process creating a potentially dangerous situation. Yet another problem with this approach is that gravity will pull the subjects muscles and skin away from their face's bones creating a distorted image in the resulting face cast. Accordingly, it is desirable to have a method of creating a face cast that sets in a minimal amount of time, does not require the subject to hold his breath, and does not produce an image distorted by gravity.

A more viable solution is to return to the time-tested method used by the ancient Egyptians and replace the traditional casting material with alginate. In this approach, the subject reclines or lays prone. Common plastic drinking straws are placed in the subject's nose to allow him to breathe during the casting process. Alginate is applied to the subject's face. However, when the alginate sets (hardens), it will still retain some malleability. This retained malleability will result in a deformation of the subject's image. Accordingly, it is necessary to reinforce the alginate mask with a stiff structure referred to as a mother mold. In current practice, the mother mold is a combination of cheesecloth and plaster of Paris. While the alginate face cast may set in one to three minutes, the requirement of creating a mother mold from plaster will add a significant period of time, mess, and waste to the casting process. This increased period of time may increase the discomfort to the subject, especially if they are claustrophobic. Additionally, the plaster mother mold will significantly increase the weight applied to the subject's face, creating distortion. Accordingly, it is desirable to have a method of creating a face cast that is quick and easy to use, does not create significant discomfort to the subject, and does produce an image distorted by excessive weight on the subject's face.

### SUMMARY OF THE INVENTION

The invention disclosed herein utilizes a light-weight dome as a mother mold. A platform is placed around a subject's head to support the casting material. A gasket is used to seal the platform around the subject's face and the platform to the dome. Custom-fit breathing tubes are inserted into the subjects nostrils and extended outward through the dome to provide a path for air to reach the subject. The dome includes an opening to allow the casting material to be placed into the dome with a funnel or casting material injector.

The casting material, such as alginate, is poured into the dome to cover the face. The platform supports a significant amount of the casting material's weight, reducing discomfort to the subject and distortion to the resulting face cast. By using a combination of fast-setting face casting material, such as alginate, along with the platform and dome face casting system described herein, the period of time during which the casting material remains in contact with the subject's face is dramatically reduced. For example, a traditional face casting process requires the face casting material to remain in place while the mother mold is constructed over the face casting material. This period may extend upwards of 20 minutes to an hour. Using the face casting system which is the subject of this application, the alginate may set in as little time as 30 seconds and may be immediately removed as the dome serves as the mother mold.

The custom-fit breathing tubes provide maximum comfort for the subject and create an optimal seal to prevent casting material from entering the subject's nose. Additionally, a custom-fit breathing tube will prevent distortion of the subject's nostrils, thereby further reducing distortion of the resulting face cast. If the subject wishes to watch the process prior to the casting material actually being applied to his face, the dome may be transparent. An optional mirror may be provided to increase the subject's view of the process. Alternatively, an opaque dome may be used to create a secluded environment for the subject in an attempt to relax the subject.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1a is an illustration of a face and head casting system, according to the invention, including a dome and a platform and an optional chair for holding a subject and supporting the dome and platform.

FIG. 1b is an illustration of a face and head casting system, according to the invention, including a portable support structure to support the dome and platform of FIG. 1a.

FIG. 2a is an illustration of the face casting system of FIG. 1 more fully illustrating the dome including custom breathing tubes, holes for inserting the breathing tubes through, and a hole for introducing casting material.

FIG. 2b is an illustration of the dome of FIG. 2a placed over the face of a subject.

FIG. 3 is an illustration of the face casting system of FIG. 1 including a platform, a support plate, a gasket, a dome, a feed tube, a feed tube collar, and a funnel.

FIG. 4a is a perspective view of the platform of FIG. 3.

FIG. 4b is a top view of the platform of FIG. 4a.

FIG. 5a is a perspective view of the support plate of FIG. 3.

FIG. 5b is a top view of the support plate of FIG. 5a.

FIG. 6a is a perspective view of the gasket of FIG. 3.

FIG. 6b is a top view of the gasket of FIG. 6a.

FIG. 7a is a perspective view of the dome of FIG. 3 including breathing tube holes, an inlet hole, and a flange.

FIG. 7b is a top view of the dome of FIG. 7a.

FIG. 8a is a perspective view of the feed tube and funnel of FIG. 3.

FIG. 8b is a perspective view of the feed tube collar of FIG. 3.

FIG. 9 is a perspective view of a casting material injector that may be used in place of the funnel of FIG. 3.

FIG. 10 is an illustration of the face casting system of FIG. 1 including a platform, a support plate, a gasket, a dome, a feed tube, a feed tube collar, and the casting material injector of FIG. 9.

FIG. 11a is a perspective view of a back dome that may be used in conjunction with the face casting system of FIG. 3.

FIG. 11b is a top view of the back dome of FIG. 11a.

FIG. 12 is a flow chart illustrating the process of creating a face mask according to the invention.

### DESCRIPTION OF THE PREFERRED EMBODIMENTS

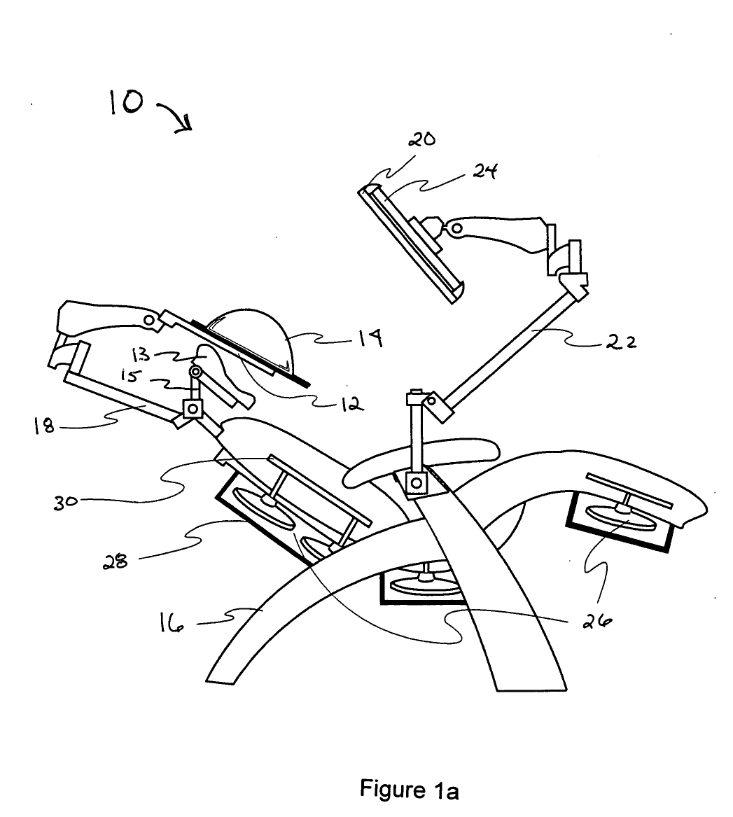

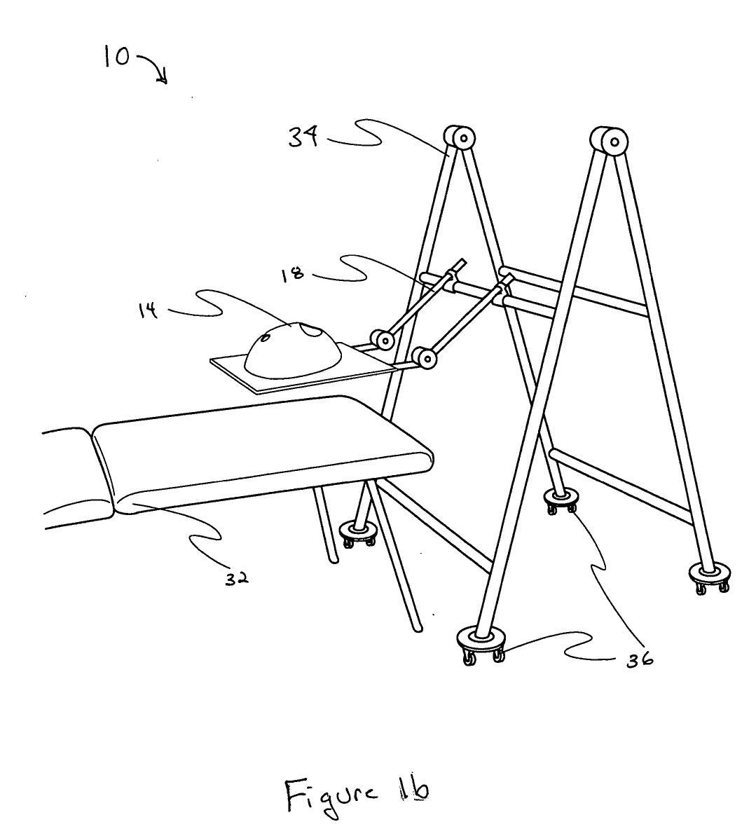

This invention is based on the idea of using a platform to support the weight of casting material and a dome to act as a mother mold for a face and casting system. Referring to the figures, wherein like parts are designated with the same reference numerals and symbols, FIG. 1a is an illustration of a face casting system 10 including a platform 12 and a dome 14. In this illustration, the face casting system includes a reclining chair 16 such as may be used in a salon or dentist office. However, the platform 12 and dome 14 may optionally be placed in a manner that allows a subject to sit upright or stand so as to more accurately replicate the customary effect of gravity on the subjects facial features.

In the example illustrated by FIG. 1a, the reclining chair 16 facilitates a comfortable environment for the subject. To aid in positioning the platform in an optimal and comfortable position, an optional multi-position arm 18 may be used to support the platform 12. If the subject wishes to view the face casting process, the dome may be made from a transparent material such as clear plastic, clear Plexiglas, or glass. An optional mirror 20 may be supported by another multi-position arm 22. Alternatively, the mirror 20 may include a two-way mirror that reflects an image toward a subject while allowing light to pass through from a display screen 24. The display screen 24 may be an liquid-crystal display (“LCD”) adapted to display patterns, images, computer animation, music videos, or other types of mood-setting images The reclining chair 16 may be fixed, may be manipulated manually, or may include electric motors and controls for easily adjusting the height of the subject and the angle of declination.

Another optional feature of this invention is the ability to produce sound and vibration that is directed at the subject. For example, the chair 16 may include acoustic transducers 26 that respond to electrical signals such as may originate with a sound-system to produce both sound and vibration directed at the subject. In FIG. 1a, the acoustic transducers 26 are placed within sound-insulating enclosures 28 that serve to direct the sound and vibration produced by the acoustic transducer toward the subject. Additionally, the acoustic transducers 26 may be connected to a sound plate 30 that vibrates as the acoustic transducers vibrate. Yet another optional feature of this invention is the multi-positional headrest 13 which is connected to the chair 16 by yet another multi-positional arm 15.

In FIG. 1b, the reclining chair 16 has been replaced by a subject support structure 32 such as a table and the multi-positional arm 18 has been attached to a portable support structure 34. In this example, the portable support structure includes wheels 36 so that it may be easily positioned over the face of a subject and just as easily removed from the vicinity of the subject.

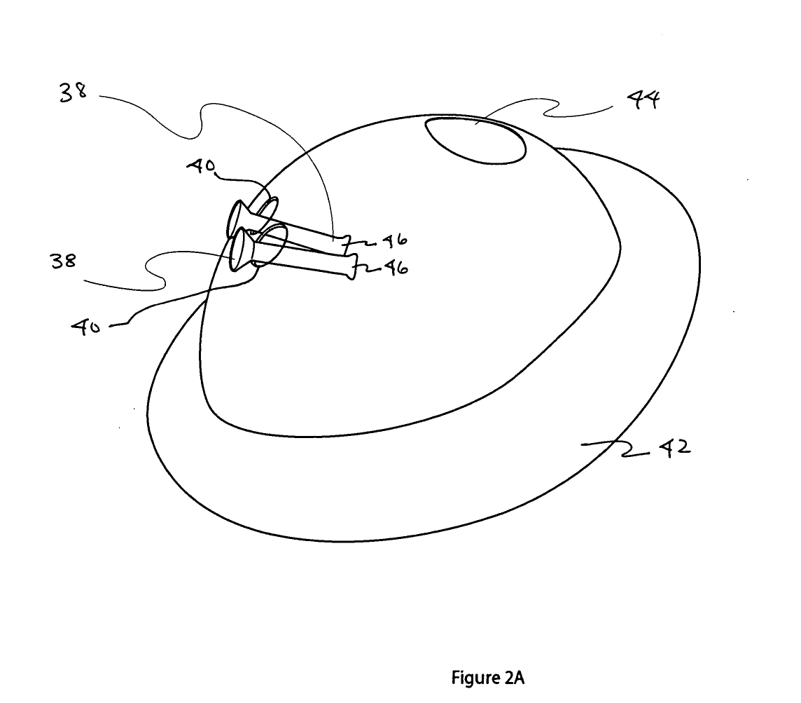

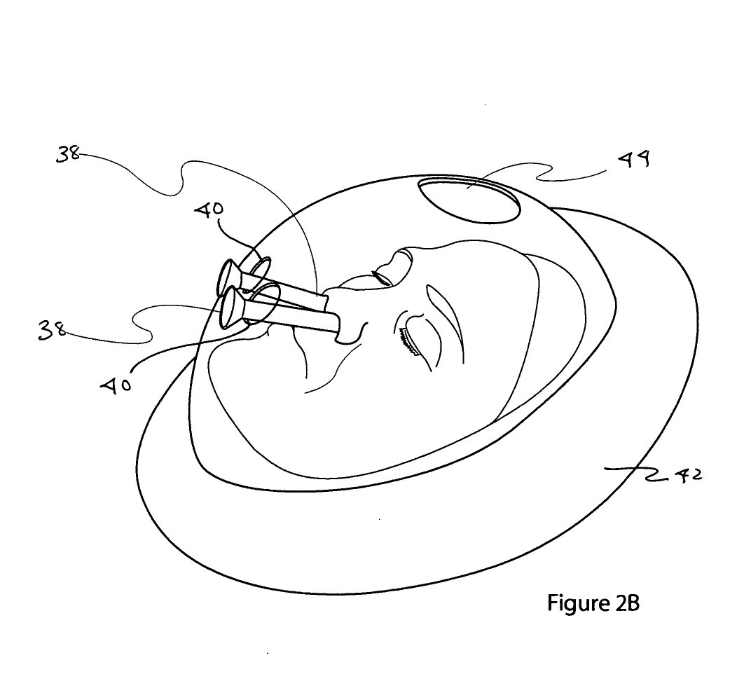

In FIG. 2a, an illustration of the dome 14 face casting system 10 of FIG. 1a, breathing tubes 38, breathing tube holes 40, a flange 42, and an inlet hole 44 are shown. The purpose of the breathing tubes is to allow a subject to breath while their face is covered with casting material. The breathing tubes 38 are small enough to be inserted through the breathing tube holes and designed to fit comfortably in the nostrils of the subject. In order to prevent distortion of the subject's nose during a face casting procedure, the breathing tubes include ends 46 that are sized and shaped to conform to the subject's nostrils. In order to facilitate this feature, the breathing tubes may be custom made for each subject or selected from a plurality of pre-made breathing tubes of various sizes. The flange 42 is designed to help produce a seal with the platform 12 (FIG. 1a). The inlet hole is designed to accept casting material. FIG. 2b is the dome of FIG. 2a illustrating its placement over the face of the subject of a fact casting procedure. The breathing tube ends 46 have been inserted into the nostrils of the subject.

FIG. 3 is an illustration of the face casting system of FIG. 1a including a platform 12, a support plate 48, a gasket 50, a dome 14, a feed tube 52, a feed tube collar 54, and a funnel 56. The support plate 48 rests on top of the platform and, in turn, supports the gasket 50 and dome flange 42. The gasket rests on top of the support plate 48, fits snugly around the face of the subject forming a first seal, and forms a second seal between the dome flange 42 and the support plate 48. To facilitate the formation of the seals, the gasket may be made of a compressible material such as neoprene. In this embodiment of the invention, clips 58 are used to secure the dome flange 42 to the support plate 48.

The feed tube 52 is connected to the inlet hole (not shown) by a feed tube collar 54. The purpose of the feed tube is to provide a path for casting material to enter the interior of the dome 14. The feed tube allows the casting material to be introduced at an elevation that is comfortable and efficient for the person pouring the casting material and directs it to the dome surrounding the subject's face at a location that is comfortable and efficient for the subject. The funnel 56 may be used to facilitate the introduction of the casting material into the feed tube 52.

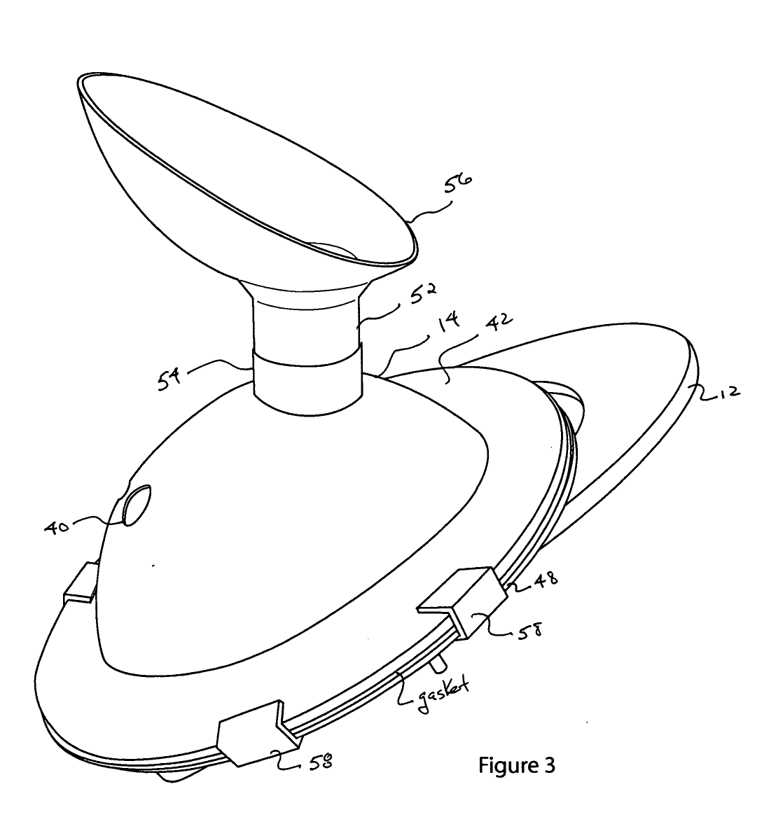

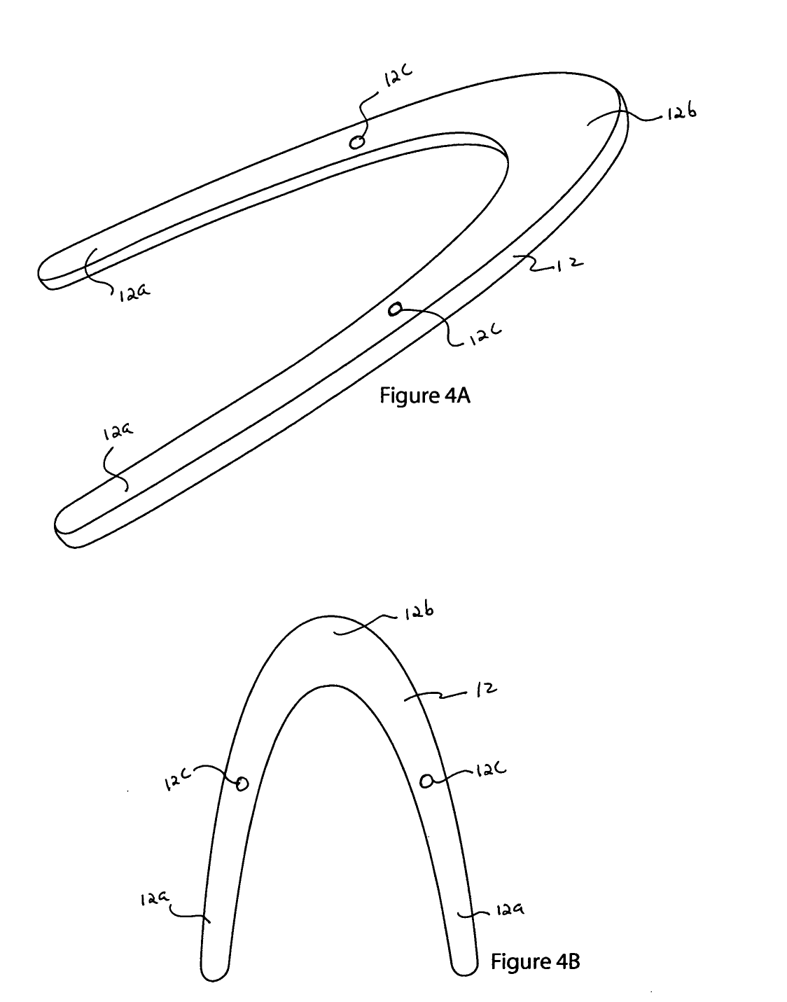

The platform 12 is more fully illustrated by the perspective view of FIG. 4a and the top view of FIG. 4b. In this embodiment, the platform conforms to a roughly U-shape. The sides 12a and back 12b of the platform 12 provide a base upon which to place the support plate 48 (FIG. 3) while leaving an opening at the front of the platform to allow the platform to be easily placed around the head of the subject. Peg holes 12c may be included to accept pegs from the support plate 48.

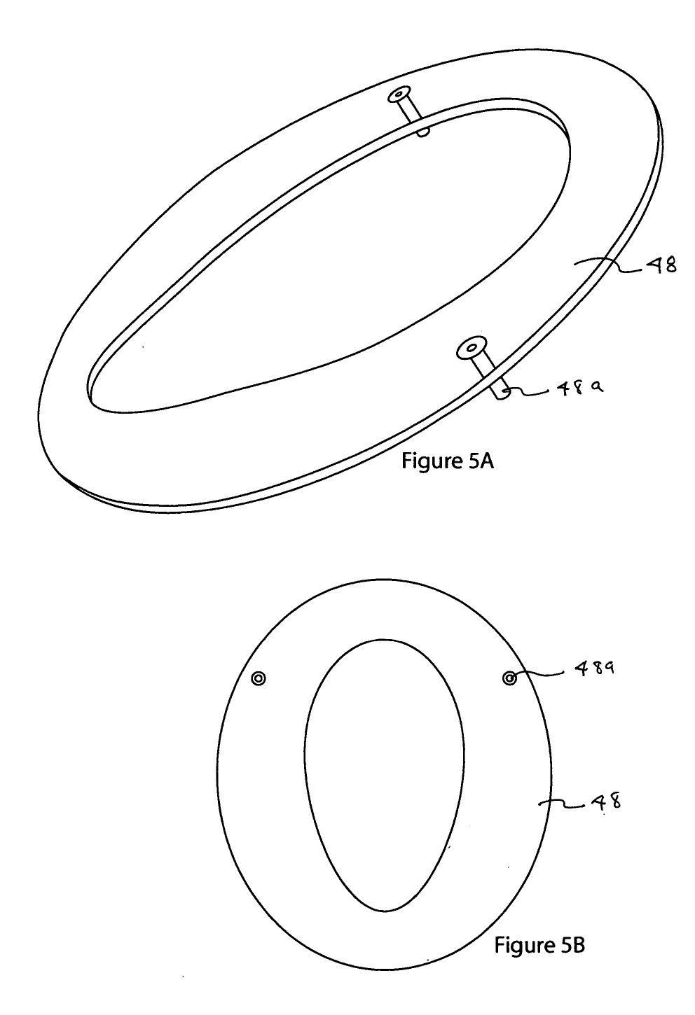

The support plate 48 is more fully illustrated by the perspective view of FIG. 5a and the top view of FIG. 5b. The support plate 48 rests on top of the platform and generally conforms to the size and shape of the subjects head. The support plate is secured to the platform 12 by inserting pegs 48a into the peg holes 12c of the platform 12.

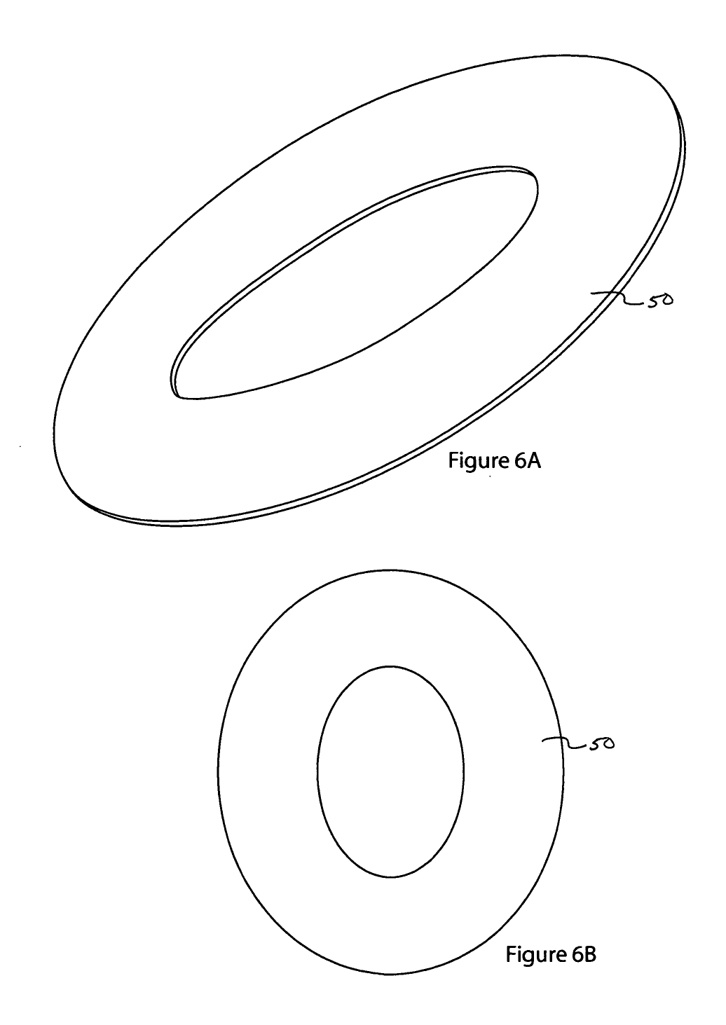

The gasket 50 is more fully illustrated by the perspective view of FIG. 6a and the top view of FIG. 6b. The gasket 50 more closely approximates the size and shape of the subject than does the support plate 48. An opening in the middle of the gasket is intended to be slightly smaller than the subjects face. As previously indicated, the gasket may be made from a compressible material, such as neoprene, so that it compresses as the opening is forced to conform to the size and shape of the subject's face forming a seal. The gasket 50 also forms a seal between by being compressed between the dome flange 42 (FIG. 3) and the support plate 48 (FIG. 3).

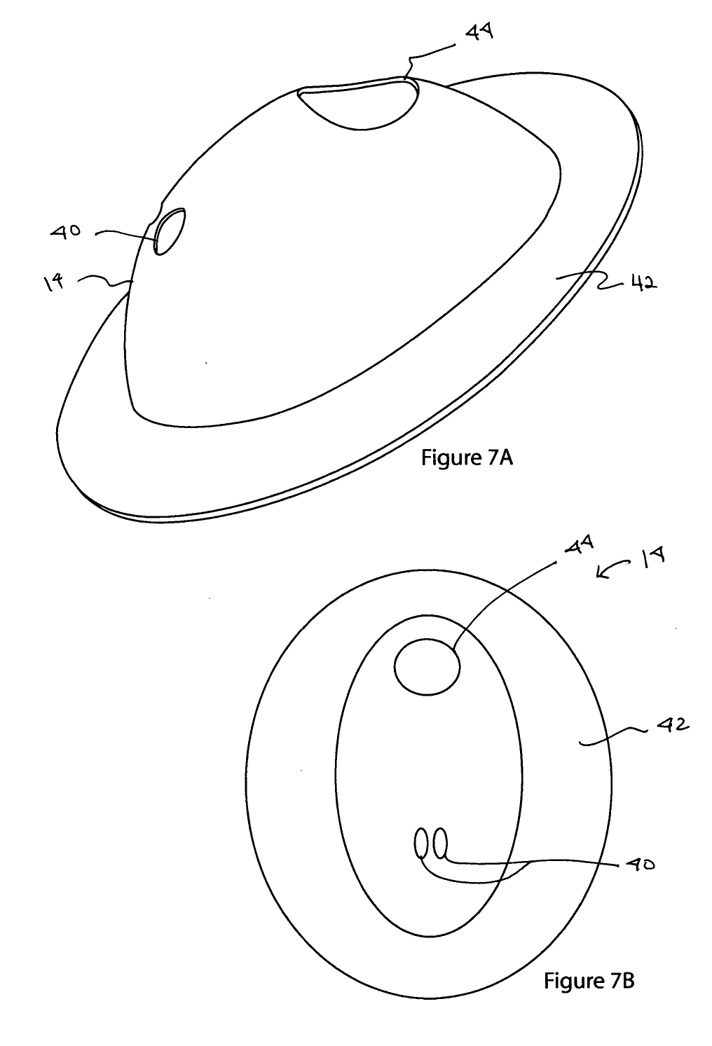

The dome 14 is more fully illustrated by the perspective view of FIG. 7a and the top view of FIG. 7b, including the breathing tube holes 40, the inlet hole 44, and the dome flange 42. The purpose of the dome is to hold the casting material while it sets around the subject's face. The dome 14 also acts as a master mold, support the face cast after it has been removed from the subject's face. The dome flange is placed over the gasket (FIGS. 6a,6b) and secured to the support plate 48.

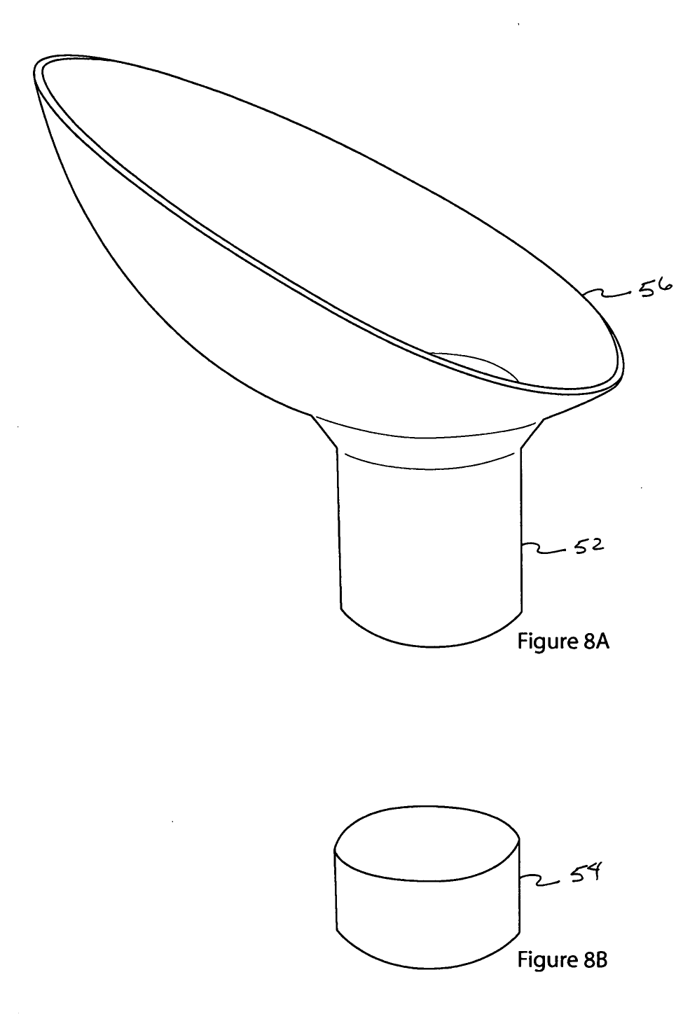

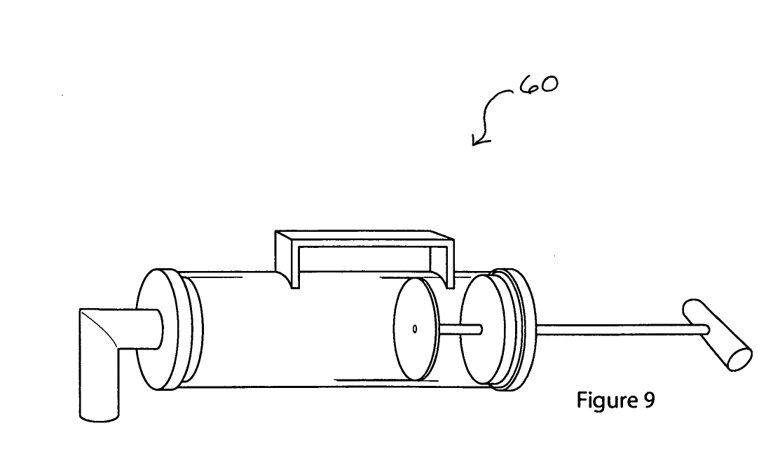

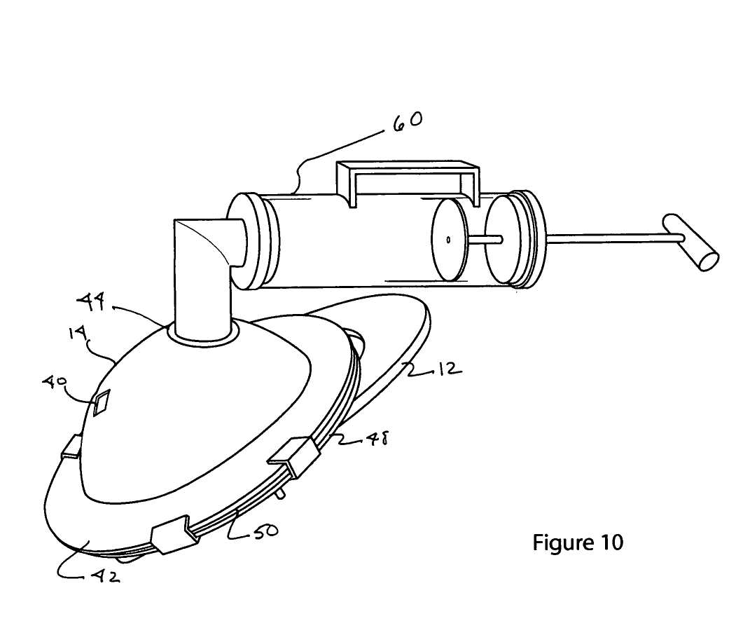

FIG. 8a illustrates the feed tube 52 and funnel 56 used to introduce casting material into the inlet hole (FIG. 7a). The feed tube collar 54 illustrated in FIG. 8b is used to connect the feed tube 52 to the dome 14. The casting material injector 60 may be used in lieu of the funnel 56 to more rapidly introduce casting material into the dome and reduce mess and waste of casting material. FIG. 10 more fully illustrates the use of the casting material injector 60 of FIG. 9, with the casting material injector being placed so as to introduce casting material through the inlet hole 44.

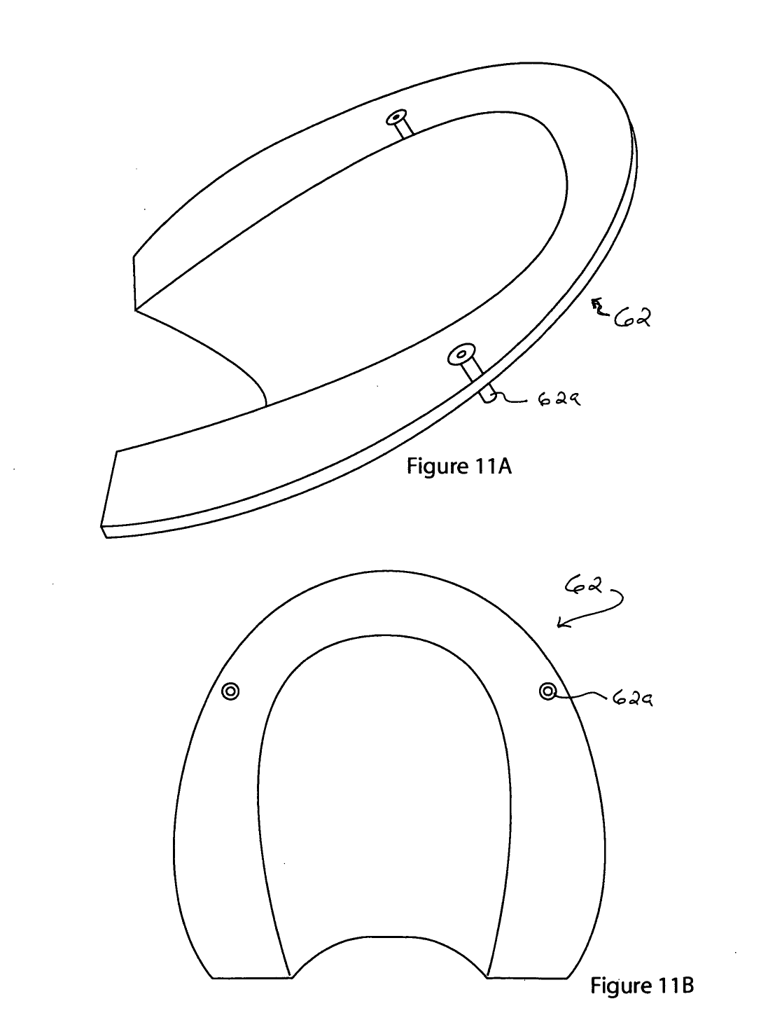

FIGS. 11a and 11b illustrate the perspective view and top view of a back dome 62 used in conjunction with the face casting system of FIG. 3. By connecting the back dome 62 to the platform 12, an entire head cast may be created. Additional pegs or other similar connecting device may be used to position the back dome 62 in relation to the platform 12. Additionally, the clips 58 of FIG. 3 may be used to secure the back dome 62 to the rest of the face casting system.

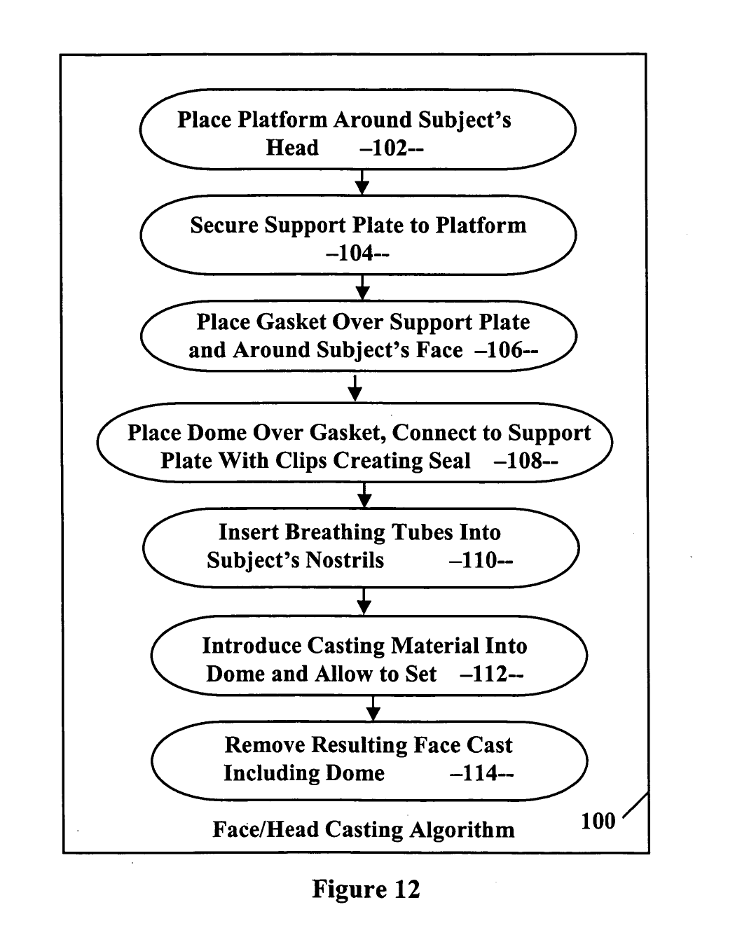

FIG. 12 is a block diagram illustrating the process of creating a face cast using the face casting system 10. A face-casting algorithm 100 begins by placing the platform 12 around the subject's head in step 102. In step 104, a support plate 48 roughly conforming to the size and shape of the subject's face is placed on top of the platform 1. A gasket 50 is then placed around the subject's face forming a seal and also placed on top of the support plate 48 in step 106. The dome 14 is placed over the gasket and secured to the support plate with a clip so that its flange 42 compresses the gasket, forming a second seal in step 108. Breathing tubes 38 are inserted through the dome 14 and inserting into the nostrils of the subject in step 110. In step 112, casting material is introduced into the dome 14 through the inlet hole 44 and conforms to the face of the subject. The subject breathes through the breathing tubes 44 during the short period that the casting material sets. Once the casting material has set, the resulting face cast including the dome 14 acting as a mother mold is removed from the subject's face in step 114. It should be noted that the elements of the instant invention are directed to creating a face cast in a quick and efficient manner that is comfortable for both the subject and the person creating the face cast.

Additional measures may be taken to ensure the comfort of the subject. For example, using a transparent dome 12, the subject may view the face casting process up until the time the casting material is introduced into the dome 12. The optional mirror 20 can facilitate this viewing. Alternatively, a non-transparent dome may be used to create a secluded environment for the subject. Optionally, music may be played during the process to help create a soothing environment for the subject.

Those skilled in the art of making face or head casts may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A face casting system, comprising:
a platform adapted to support casting material;
a first breathing tube adapted to be placed in a first nostril of a face of the subject; and
a dome secured to the platform, said dome being adapted for enclosing at least a portion of the face of the subject and having an access hole for receiving the casting material and a first tube hole for receiving the first breathing tube.

2. The face casting system of claim 1, further comprising a second breathing tube adapted to be placed in a second nostril of the face of the subject and wherein the dome includes a second tube hole for receiving the second breathing tube.

3. The face casting system of claim 2, further comprising a first support arm adapted to support the platform.

4. The face casting system of claim 3, further comprising a chair adapted to hold the subject and the first support arm.

5. The face casting system of claim 4, wherein the chair is adapted to adjust the subject's angle of inclination.

6. The face casting system of claim 4, further comprising a mirror connected to the chair by a second support arm.

7. The face casting system of claim 2, wherein the first and second breathing tubes are custom made for the subject.

8. The face casting system of claim 2, wherein the first and second breathing tubes are selected from a plurality of breathing tubes including a variety of common sizes.

9. The face casting system of claim 2, further comprising a funnel connected to the access hole, said funnel being adapted to channel the casting material into the dome.

10. The face casting system of claim 4, further comprising a head-rest connected to the chair.

11. The face casting system of claim 2, further comprising a casting material injector inserted into the access hole, said casting material injector being adapted to introduce casting material into the dome.

12. The face casting system of claim 4, wherein the chair further includes acoustic transducers.

13. The face casting system of claim 1, further comprising a back dome connected to the platform, said back dome being adapted to produce a full head cast of the subject.

14. The face casting system of claim 6, wherein the mirror includes a two-way mirror adapted to reflect an image of the subject from a first side of the two-way mirror while transmitting a second image imposed upon a second side of the two-way mirror.

15. The face casting system of claim 14, further comprising a video display adapted to produce the second image.

16. A method of creating a face cast, comprising the steps of:
placing a platform in the vicinity of a face of a subject;
securing a dome having an access hole for receiving the casting material and a tube hole for receiving a first breathing tube to the platform, said dome being adapted to act as a mother mold for the face cast;
placing a breathing tube through the tube hole and into a first nostril of the face of the subject;
introducing casting material into the dome through the access hole;
waiting for the caster material to set; and
removing the resulting face cast including the dome from the subject's face.

17. The method of claim 16, further comprising connecting the platform to a chair prior to the step of placing the in the vicinity of the face of the subject.

18. The method of claim 16, wherein the step of introducing casting material into the dome includes using a funnel.

19. The method of claim 16, wherein the breathing tube is selected from a plurality of breathing tubes including a variety of common sizes.

20. The method of claim 16, wherein the step of connecting the platform to a chair includes using a multi-positional arm.
